(19) United States
(12) Patent Application Publication
(10) Pub. No.: US 2009/0144769 A1
(43) Pub. Date: Jun. 4, 2009

(54) Digital Video Recording Device and Method

(75) Inventors: Valerie Sacrez Liebhold, Ashland, MA (US); Scott Allan Kendall, Lexington, KY (US)

Correspondence Address: Robert D. Shedd;Thomson Licensing LLC, 2 Independence Way, PRINCETON, NJ, 08543-5312, US

(73) Assignee: THOMSON LICENSING, Boulogne-Billancourt (FR)

(21) Appl. No.: 12/084,311

(22) PCT Filed: Nov. 3, 2005
(86) PCT No.: PCT/US2005/039951

§ 371 Date: Apr. 28, 2008

(51) Int. Cl. H04N 5/445; H04N 7/173

(52) U.S. Cl. 725/39; 725/131

(57) ABSTRACT

A multi-media content playback method comprising: detecting a user request to play-back stored multi-media content for a selected program; determining whether a loss of signal (LOS) condition is associated with the stored multi-media content; and if a LOS condition is determined to be associated, alerting the user, prior to play-back of the stored multi-media content, that at least a portion of the multi-media content for the selected program is missing.

### TECHNICAL FIELD

The present invention relates generally to digital video recording and playback devices.

### BACKGROUND OF THE INVENTION

Digital recording devices such as personal video recorders (PVRs) are growing in popularity. PVRs are sometimes referred to as hard disk recorders (HDRs), digital video recorders (DVRs), personal video station (PVSs), or personal TV receivers (PTRs). Two commercially available PVR systems are known under the tradenames TiVo and ReplayTV.

A digital recording device may conventionally receive data streams to record from a multi-media content distribution network, such as a Digital Television (DTV) broadcast network. Some examples of DTV networks include terrestrial digital television broadcast networks, satellite television networks (e.g., DirecTV and Dish Network) and digital cable networks. Receivers for such systems, either in the form of integrated receivers and access cards like cable cards, or separate receivers, such as satellite and digital cable receivers (e.g., set-top boxes), may experience loss of signal (LOS) from time-to-time. LOS may result from a number of causes, such as heavy storms or sun interference in the case of satellite television receivers, for example.

When a LOS condition exists, corresponding DTV broadcast reception will be interrupted, such that a digital recording device recording of corresponding content will be missing portion(s) of program data. This inevitably results in an incomplete recording. In such a case, a user may start watching a play-back of a recorded show, only to notice after a while that one or more major portions of the program are missing. This may prove frustrating to the user because, for example, the user does not receive an indication whether a portion of the recorded program is missing before starting playback of the program.

### BRIEF SUMMARY OF THE INVENTION

Therefore, there is a need for overcoming the problems described above, in particular for detecting whether a loss of signal condition has occurred during a recording of a program signal, and providing an indication to the user of the loss of signal condition.

A recording device according to the invention comprises a receiver for receiving a signal representative of a program transmitted during a particular time period; a memory for storing the received program signal; a detector coupled to the receiver for detecting occurrence of a loss of signal condition, in which the signal is not received by the receiver during the particular time period; and a processor, coupled to the detector, and operative to generate a signal representing a message indicative of a portion of the program being missing from a recording of the program in the memory, in response to detection of the loss of signal condition.

A content playback method according to the invention comprises: receiving a signal representative of a program transmitted during a particular time period; storing the received program signal; detecting occurrence of a loss of signal condition, in which the signal is not received during the particular time period; and providing a message indicating that a portion of the program is missing from a recording of the program, in response to detection of the loss of signal condition.

In another aspect, the invention provides for a method for playing back recorded programs, comprising: detecting a user request to play-back a recorded program; determining whether a loss of signal (LOS) condition is associated with the recorded program; if a LOS condition is associated with the recorded program, generating a message indicating that a portion of the program is missing; and displaying the message prior to playback of the recorded program.

### BRIEF DESCRIPTION OF THE DRAWINGS

Understanding of the present invention will be facilitated by consideration of the following detailed description of the preferred embodiments taken in conjunction with the accompanying drawings, wherein like numerals refer to like parts and:

FIG. 1 illustrates a block-diagrammatic view of a device according to an embodiment of the present invention;

FIG. 2 illustrates a block-diagrammatic representation of a memory suitable for use with the device of FIG. 1 according to an embodiment of the present invention;

FIG. 3 illustrates a flow-diagrammatic representation of a process suitable for use with the device of FIG. 1 according to an embodiment of the present invention; and,

FIGS. 4-8 illustrate graphical user interfaces according to embodiments of the present invention.

FIG. 9 illustrates a process flow associated with an embodiment of the present invention.

### DETAILED DESCRIPTION OF THE PREFERRED EMBODIMENTS

It is to be understood that the figures and descriptions have been simplified to illustrate elements that are relevant for a clear understanding of the present invention, while eliminating, for purposes of clarity, many other elements found in typical digital television signal receiver and recorder systems, and methods of making and using the same. Those of ordinary skill in the art will recognize that other elements are desirable and/or required in order to implement the present invention. However, because such elements are well known in the art, and/or because they do not facilitate a better understanding of the present invention, a detailed discussion of such elements is not provided herein.

According to an aspect of the present invention, a user of a digital video recording device may be alerted that a recording of a program selected for viewing by the user was interrupted by a LOS event, thereby causing a portion of the program content to be missing from the recorded program. Such notification is provided to the user upon attempted play-back of the content. The user is thus alerted to the condition that recorded content is missing from the selected program prior to play-back. This enables the user to make a more informed decision as to whether to invest substantial time and resources in viewing a recorded program that may be missing valuable program content.

According to another aspect of the present invention, should play-back of a recorded program having a portion of its content omitted resulting from an LOS condition be desired, a streamlined method of presenting the program may be implemented. A recurrence or re-broadcast of a program having missing recorded content may automatically be searched for, and optionally recorded. The user may then be presented with an option as to which recording he/she wishes to view.

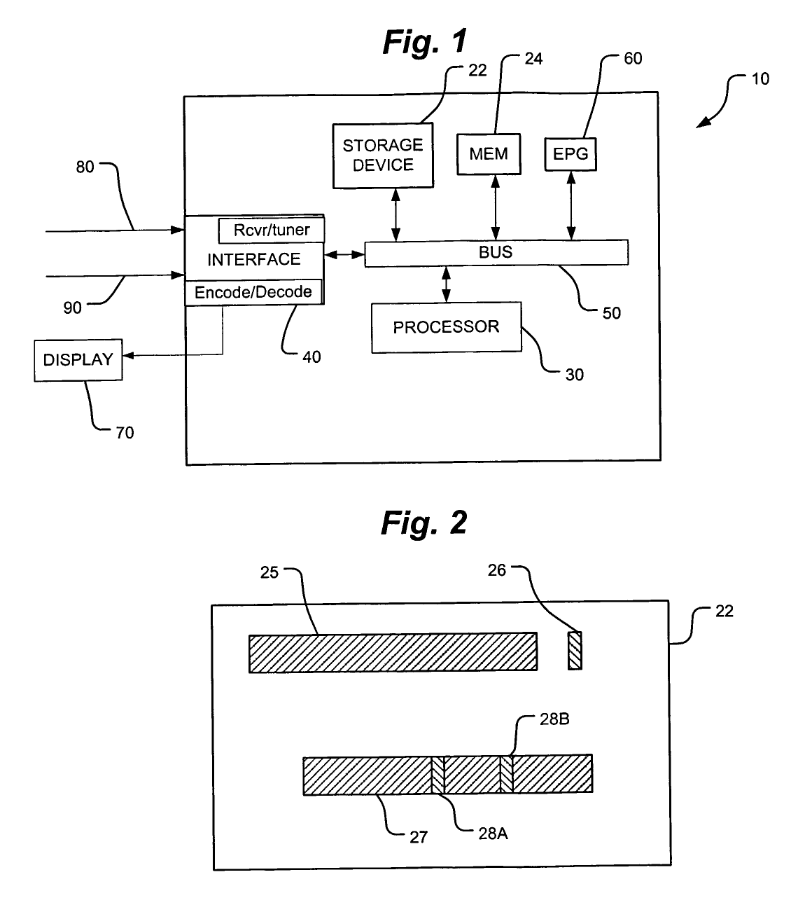

Referring now to FIG. 1, there is shown a block-diagrammatic view of a digital video recording device 10 according to an aspect of the present invention. Device 10 may be integrated into a display device such as a digital television, or a set-top unit or box, for example. In one embodiment, digital video recording device 10 is a personal video recorder (PVR). In another embodiment, digital video recording device 10 is a digital video recorder (DVR). It should be appreciated that digital video recording device 10 may be any electronic device for use in recording and playing recorded programs, and is not intended to be limited to PVRs and DVRs.

Device 10 may provide for receiver functionality including PVR capabilities for receiving multimedia program content. Device 10 includes an interface 40 for receiving and/or decoding, in cooperation with processor 30 and/or memory 24, multimedia program content data. Such data may be in the form of a broadcast signal 80 in either analog or digital format. Where the broadcast signal is an analog signal, the analog signal is converted to a digital signal. In one embodiment, the broadcast signal is an MPEG data stream received over a cable from a cable television provider. In another embodiment, the broadcast signal is received from a satellite broadcast by a satellite television provider. In yet another embodiment, the broadcast signal is transmitted over the airways from a broadcast tower by a television broadcaster (e.g., a television station). It should be appreciated that the broadcast signal can be any signal for rendering on an audio/video display device, and is not intended to be limited by the aforementioned embodiments.

In an exemplary configuration digital video recording device 10 comprises a digital video encoder configured to receive broadcast signals 80 containing program content and digitize an analog signal into a digital format for storage. As shown in FIG. 1, digital video recording device 10 comprises bus 50 for communicating information, processor 30 coupled with bus 50 for processing information and instructions, memory 24 (e.g., volatile or non-volatile memory, including random access memory, static RAM, dynamic RAM, read only memory, programmable ROM, flash memory, EPROM, EEPROM, etc.) coupled with bus 50 for storing information and instructions for processor 30 and data storage device 22 coupled with bus 50 for storing program content data. It should be appreciated that data storage device 22 can be any memory or storage medium for storing digital data, such as a magnetic or optical disk and disk drive. Furthermore, data storage device 22 can have any amount of storage space.

“Processor”, as used herein, refers generally to a computing device including a Central Processing Unit (CPU), such as a microprocessor. A CPU generally includes an arithmetic logic unit (ALU), which performs arithmetic and logical operations, and a control unit, which extracts instructions (e.g., code) from memory and decodes and executes them, calling on the ALU when necessary. The memory utilized by the processor may be internal or external to an integrated unit including the processor. For example, in the case of a microprocessor, the memory may be internal or external to the microprocessor itself. Of course, other elements may be used, such as an Application Specific Integrated Circuit (ASIC), for example.

Device 10 may further include a power supply and other ancillary components (not pictured) for facilitating recording and playback processing associated with a digital video recording device. Processor executable code is stored in a processor-readable medium, i.e., memory 24 such that, when accessed and executed by processor 30, allows for user interaction with the device 10. Programming information in the form of an electronic program guide (EPG) 60 may be provided to facilitate recording and play-back of data streams that correspond to user selected programming. As is understood by those possessing an ordinary skill in the pertinent arts, an EPG presents a user with available program choices. EPGs conventionally use transport stream identifiers (TSIDs) to facilitate identifying and tuning different programs from received signals. Digital video recording device 10 also comprises a digital video decoder for receiving a recorded program in a digital format and decoding the signal for rendering on an audio/video display device 70. The audio/video display device may be a television, a PVR display screen, or other such display. In another embodiment, digital video decoder receives and decodes a recorded program stored in a digital format on storage device 22.

Digital video recording device 10 further operates to receive user commands 90 via an interface such as interface 40. User commands may emanate from a remote control communicatively coupled to the device by a wireless connection, or may be input manually. It should be appreciated that user commands may be received in response to interaction with a graphical user interface rendered on an audio/video display device 70 which may be integrated with device 10 or externally coupled thereto. User commands direct digital video recording device 10 to perform specific functions associated with the recording and/or playback of a selected program.

DTV broadcast receivers typically display signal loss or signal being re-acquired screen upon detecting a LOS condition. Conventional DTV receivers detect LOS conditions. However, these messages provide no notice prior to play-back of a recorded show that a portion of the show was not recorded. According to an aspect of the present invention, device 10 may monitor for a signal loss or re-acquisition condition. This may be accomplished by monitoring for the condition in a manner analogous to that used to display a LOS screen (i.e., directly), or by monitoring for the LOS screen itself, (i.e., indirectly). The LOS screen is generated via a processor coupled to the receiver, for providing a loss of signal (LOS) display in response to a determined loss of signal condition of the received signal containing program content.

Referring now to FIG. 1 in conjunction with FIG. 2, broadcast signal data containing program content for recording (and ultimate playback) is transmitted from a source and received at interface 40 via one or more input ports of recording device 10. However, due to any number of reasons, device 10 may lose the transmitted signal, thereby resulting in a portion of the program content being omitted or missed upon recording. Processor 30 upon executing code stored in memory 24, monitors for the LOS condition either directly or indirectly. In one embodiment, when a LOS condition is detected, processor 30 operates to set one or more indicators or flags 26 indicative of the detected LOS condition and being associated with the corresponding program and the recorded program content 25. “Flag”, as used herein, generally refers to a software or hardware element that signals a particular condition or status. A flag may be said to be set when it is turned on. Of course, a system that sets flags by negating them may also be used. Flag(s) 26 may be stored in memory 22 or 24, or may be stored in a separate file, and associated with select portions (e.g. certain frames, headers, scenes, etc.) of the program content recorded. In the illustrated case, flag(s) 26 are stored in memory 22.

The one or more flags may be inserted with the recording of the program (in a header field for example, associated with the program recording) and accessible upon a request for playback of the recorded program. Alternatively, the one or more flags may be stored in a separate flag table having an associated mapping to the list of recorded programs (e.g. via program ID), such that, upon request for playback of a particular recorded program, the device obtains the program ID associated with the requested program and searches the flag table for that program ID. If the program ID is found in the flag table, then a LOS condition is determined to exist and the device operates to notify the user prior to commencing playback of the requested program. The one or more flags may be included in metadata associated with the particular program being recorded.

In one configuration, the flag may simply function as an indicator associated with a particular program (e.g. via program ID) of whether an LOS condition has been detected in that recording. In another configuration, the flag may provide additional timing information (e.g. timestamp information) that may be used in conjunction with start and end periods for the detection of an LOS condition, in order to provide additional detail with regard to the duration of the LOS condition, and/or the relative location of the LOS within the program recording, for example.

In an exemplary embodiment, when device 10 includes a receiving tuner such as a satellite receiver, in addition to a hard drive storage medium for recording the received program content, the satellite receiver is operable to mark flags when the signal is lost and when the signal is recovered. The flag information is sent to the recorder for recording along with the program content. In this manner, if flags marking signal loss exist in the recording, a user will be alerted to this condition upon subsequent selection of the recorded program for playback.

In another embodiment, IRE levels may be monitored in a manner similar to that of a conventional “commercial advance” PVR feature. As is understood by those possessing an ordinary skill in the pertinent arts, the IRE level is a measure of the amplitude of a video signal. PVRs may conventionally monitor the IRE level of a program for low IRE segments, that also have low audio components and that meet some predetermined criteria (e.g. being 30 seconds apart) to identify potential commercial start- and end-points.

In an exemplary embodiment, monitoring of IRE level for stability or a constant value, optionally in combination with audio levels, may be used to determine whether a LOS condition exists. Instead of detecting blank screens via low IRE levels, a LOS condition may be detected using constant IRE levels to identify fixed screens (such as a screen indicating a LOS condition). Flag(s) 26 may be set dependently upon detecting a substantially constant IRE level over a given interval (e.g. an interval of 5 seconds or more). Thus, processor 30 may operate in response to execution of code stored in memory 24 to detect IRE levels of a multi-media content signal that is being recorded. If an IRE level is measured to be substantially constant over a sufficient period of time (such as over 5 seconds), it may be taken to indicate a fixed image, and hence a LOS message display. Flag(s) 26 may be set accordingly. In this manner, detection and insertion of flags for alerting a user to an LOS condition is accomplished regardless of whether device 10 includes an internal tuner or external source. More particularly, a PVR device may not be integrated into the receiver, and thus may only obtain output from the receiver. A satellite box sending a constant IRE level could be interpreted by the device as a lost signal. The above approach alleviates this problem.

In another exemplary embodiment, an IRE average level may be measured over a number of fields and processed to determine whether the average value stays relatively constant over a given interval and within a given area of the display. For example, certain areas of the display that are likely to be flat, such as the top, bottom, or sides of the display, may be measured over a sufficiently long (e.g. 5 sec.) interval for determining average IRE levels associated with the monitored area(s). Those average IRE levels may then be compared with one or more threshold values (e.g. values indicative of a LOS screen) for determining whether an LOS condition exists. Still further, the present invention contemplates monitoring synchronization or sync associated with the incoming signal for detecting a signal loss condition and for providing an indication to a user that a portion of the program content is missing from the recorded program.

By way of further example, processor 30 may determine a derivative value of the measured IRE levels as a function of time, for determining IRE level stability. It is contemplated that other techniques in the art may also be used. Flag(s) 26 may include one or more segments that correlate to or indicate one or more of the amount of time lost or missing in the recorded program content, the relative time into the program in which the missing content occurs, and/or other relevant program information associated with the detected LOS condition.

Responsive to a play-back command, device 10 accesses flag(s) 26 associated with the requested multi-media content to determine if any portion is missing. If one or more content portions are missing, an advisory or alert message is displayed to alert the user of an LOS condition. For example, in one embodiment device 10 searches for indicators stored in memory and associated with the selected program to be played back. Such indicators correspond to the length of time associated with the missed program content. If such indicators are found, device 10 is configured to cause a message along the lines of, “2 min. 30 sec. of video is missing from this recording”, prior to play-back thereof.

Referring still to FIGS. 1 and 2, in an exemplary embodiment the device 10 operates to set flags corresponding to point 28A in the encoded data stream 27 where a LOS condition was detected, and to point 28B in the encoded data stream where a LOS ceased being detected. In such a case, device 10 may skip playing back portions of the encoded data between each set of flags 28A, 28B, so the user need not manually fast forward through an unknown length of missing content. Data informing a viewer that content is missing from that portion of the recording may optionally be inserted into the data stream for display to the user via the audio/video display device. For example, a display screen showing “Video degraded by signal loss at the time of recording is not shown” for some temporal period (e.g., 5 seconds) may be inserted at the corresponding location(s) in the encoded data stream. Optionally, a display may be presented to a user to provide an option to restore the content and verify that it was removed for legitimate reasons, such as “Video degraded by signal loss at the time of recording is not shown, press PAUSE to verify the content, press PLAY to continue.”

In one configuration, recording of content may be suspended while a LOS condition is detected. For example, rather than recording 2 minutes and 30 seconds of a LOS display screen, device 10 may optionally stop recording a data stream, or later delete that portion of the encoded data stream, and resume recording once the LOS condition ceases to be detected.

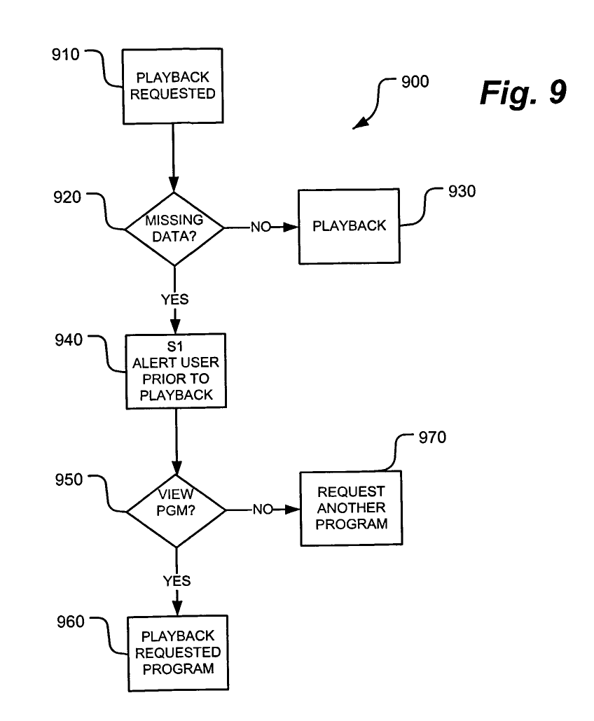

FIG. 9 illustrates an exemplary process 900 for determining and alerting the user to an LOS condition according to an embodiment of the present invention. In one configuration, code adapted to cause processor 30 to perform process 900 may be stored in memory 24. Upon detecting a user-initiated, playback request (block 910) for a recorded-content program, device 10 is configured to determine whether a portion of the requested program content is missing (block 920). Determination block 920 may include searching for and/or examining a flag associated with the requested content (e.g. program ID) and indicative of whether or not a LOS condition was detected during recording (e.g., content data 25, flag 26, or content data 27, flags 28A, 28B, FIG. 2). If content is determined not to be missing, such that the recorded program is substantially complete, conventional play-back may proceed (block 930). If a portion of the recorded content is determined to be missing (block 920), processor 30 causes a message to be displayed onto the display device that alerts the user of the LOS condition associated with the requested program (block 940), and requests confirmation that the user wishes to proceed with viewing the requested program (block 950). Upon notification, the user may then proceed with viewing the selected program containing the missing content (block 960), or decline and/or request playback of another program (block 970).

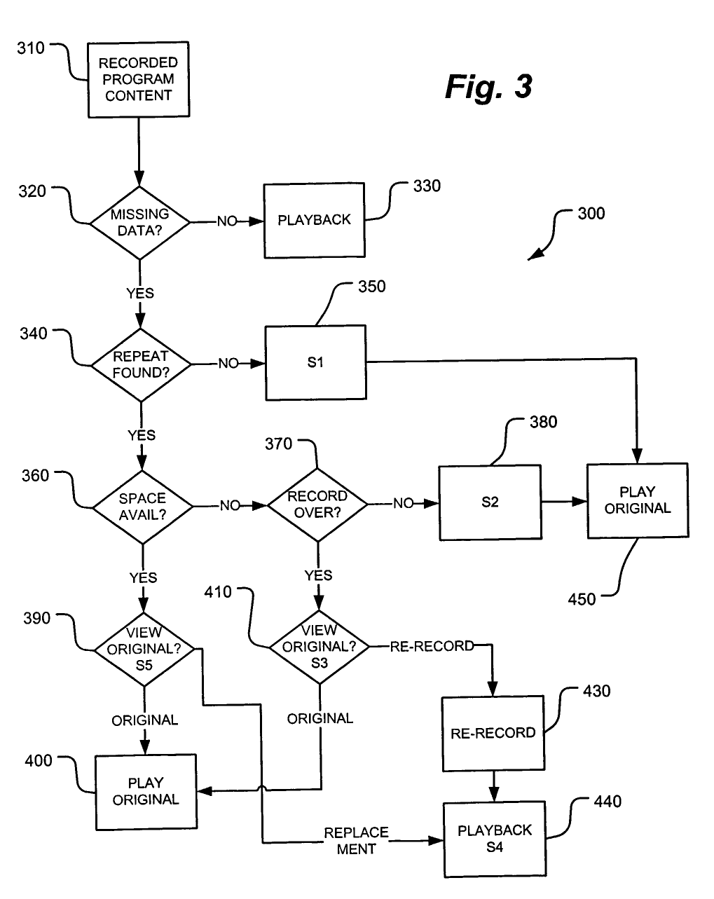

Referring now also to FIG. 3, there is shown a block-diagrammatic view of a process 300 for determining and alerting the user to an LOS condition and for automatically searching for a recurrence or re-broadcast of the program having missing recorded content for possible recording according to an aspect of the present invention. The user may then be presented with an option as to which recording he/she wishes to view.

In one embodiment, code adapted to cause processor 30 to perform process 300 may be stored in memory 24. A signal representative of program content for a particular program (e.g. in the form of a transport stream) transmitted to device 10 during a given time period is received by device 10 (FIG. 1) at the receiver and stored in memory. A detector coupled to the receiver operates to monitor and detect the occurrence of a loss of signal condition, in which the signal is not received, during the given time period. If an LOS condition is detected, one or more flags or indicators associated with the particular program being recorded are set, indicative of the LOS condition, as previously described. Upon completion of the recording of the original program content (block 310), device 10 may be configured to automatically determine whether a portion of the requested content is missing (block 320).

Determination block 320 may include searching for and/or examining a flag associated with the requested content and indicative of whether or not a LOS condition was detected during the previous recording (e.g., content data 25, flag 26, or content data 27, flags 28A, 28B, FIG. 2). If content is determined not to be missing, such that the recorded program is substantially complete, conventional play-back may proceed (block 330). If a portion of the recorded content is determined to be missing (block 320), processor 30 causes a search of EPG 60 data for a re-occurrence or planned re-broadcast (i.e. “repeat”) of the selected program content (block 340).

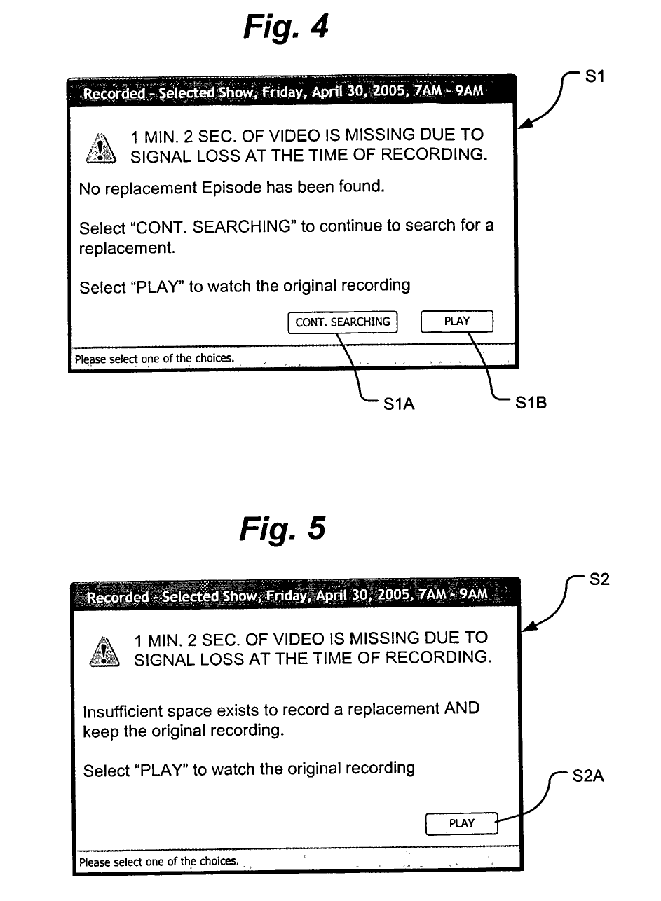

Referring now also to FIG. 4, there is shown a graphical user interface (GUI) S1. If no scheduled re-occurrence or re-broadcast is found (block 340), GUI S1 is presented to the user (block 350). As illustrated in the example of FIG. 4, GUI S1 alerts or informs the user that a portion of the content is missing from the recorded program content. GUI S1 also informs the user that no re-broadcast of the content has been located. GUI S1 may provide the user an opportunity to continue searching for a replacement program by selecting a corresponding data item S1A using a remote control for example, or to play the selected (“content-missing”) program, by selecting a corresponding data item S1B (block 450) using a remote control for example. One or more data items corresponding to a user selection to cancel play-back may also be presented.

If a repeat broadcast is found (block 340), device 10 then determines whether or not memory 22 (FIG. 1) has sufficient available capacity to record the re-broadcast and also keep the copy presently recorded (block 360). If sufficient capacity is determined to exist (block 360), the processor next determines whether or not the user wishes to view the original recording (block 390). This may be a pre-configured selection, or the user may be prompted to select the desired operation, for example.

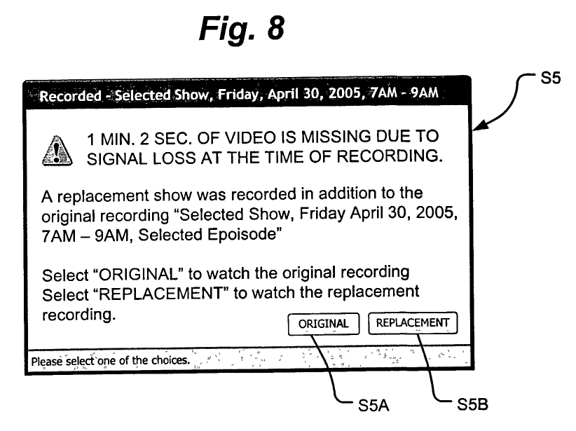

Referring now also to FIG. 8, there is shown a GUI S5 according to an aspect of the present invention. To determine if the user wishes to view the original program, GUI S5 may be provided to the user (block 390). In one embodiment, GUI S5 operates to inform the user that a portion of the content is missing from the recorded program. GUI S5 further includes information indicating to the user that a re-broadcast of the original program content has been located. In an exemplary configuration, device 10 is pre-configured to search EPG 60 for a re-broadcast and automatically record that re-broadcast where a LOS condition is detected during a recording. GUI S5 may thus provide the user an opportunity to view the original recorded content (with the missing portion(s)), by selecting a corresponding data item S5A using a remote control for example, or to view an already recorded replacement, by selecting a corresponding data item S5B using a remote control for example. One or more data items corresponding to a user selection to cancel play-back may also be presented.

If sufficient storage capacity is determined not to exist (block 360), the user is prompted as to whether to record over the previously recorded content (block 370). This decision may be pre-configured or pre-programmed according to certain criteria, or may be user selectable, for example. FIG. 5 shows a GUI S2 where the selection (block 370) is pre-configured in the negative. As shown in FIG. 5, GUI S2 operates to inform the user that a portion of the content is missing from the recording. GUI S2 is also operative to inform the user that insufficient capacity exists to record a re-broadcast of the content and to provide the user an opportunity to view the original recorded content (with the missing portion(s)), by selecting a corresponding data item S2A.

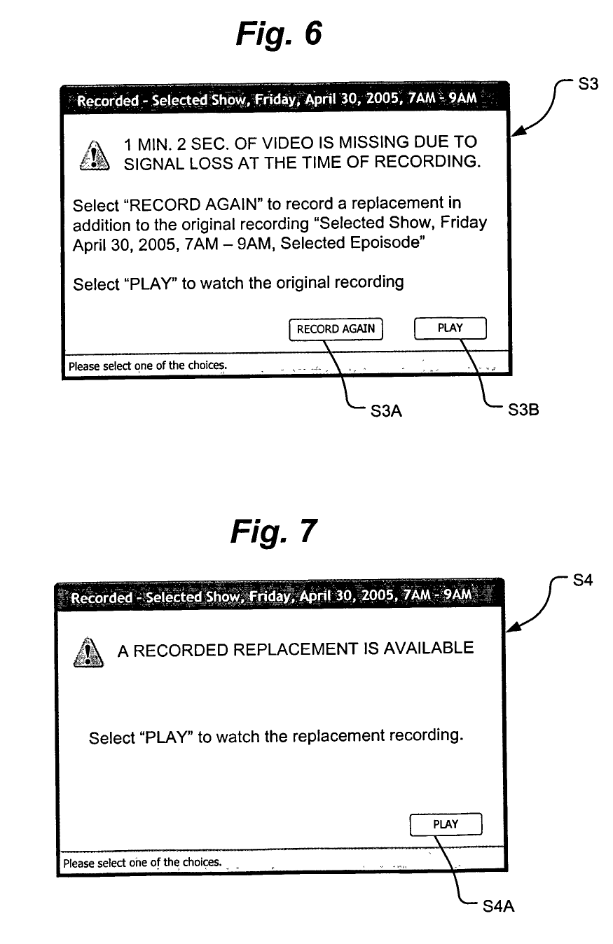

Optionally, the user may be presented with an option to record a replacement, by selecting a corresponding data item using a remote control for example. One or more data items corresponding to a user selection to cancel play-back may also be presented. If the user selects not to record over the original recording, play-back of the originally recorded program content may commence (block 450).

Where selection (block 370) is preconfigured in the positive, it is then determined whether or not the user wishes to view the original recording (block 410). Such determination may be performed automatically according to a predefined rule set, or may be user selectable. FIG. 6 provides an exemplary illustration of a GUI S3 for informing the user that a portion of the content is missing from the recording. GUI S3 may further inform the user that a re-broadcast of the program content has been located. GUI S3 thus provides the user an option to view the original recorded content (with the missing portion(s)) by selecting a corresponding data item S3B, or to record the re-broadcast content by selecting a corresponding data item S3A. One or more data items corresponding to a user selection to cancel play-back may also be presented.

If the user selects the original recorded program for viewing, play-back of the original program will commence (block 400). If the user selects to record the replacement content, the re-broadcast is recorded when it becomes available (block 430).

Referring now also to FIG. 7, there is shown a GUI S4 according to an aspect of the present invention. Once the re-broadcast has been recorded (block 430), GUI S4 is presented to the user (block 440). GUI S4 is configured to inform the user that a replacement, re-broadcast program has been recorded. GUI S4 provides the user an option to view the recorded re-broadcast content by selecting a corresponding data item S4A.

It will be apparent to those skilled in the art that various modifications and variations may be made in the apparatus and process of the present invention without departing from the spirit or scope of the invention. For example, the present invention also contemplates that the device may be configured such that the device commences searching of a rebroadcast of the program to be recorded immediately upon detection of signal loss, rather than waiting for completion of recording of the program containing missing content. Also, elements described above may be implemented within hardware components or software components as is known in the art. Thus, it is intended that the present invention cover the modification and variations of this invention provided they come within the scope of the appended claims and their equivalents.

1. A recording device, comprising:
a receiver for receiving a signal representative of a program transmitted during a particular time period;
a memory for storing the received program signal;
a detector coupled to the receiver for detecting occurrence of a loss of signal condition, in which the signal is not received by the receiver during the particular time period; and
a processor, coupled to the detector, and operative to generate a signal representing a message indicative of a portion of the program being missing from a recording of the program in the memory, in response to detection of the loss of signal condition.

2. The device of claim 1, wherein the detector generates an indicator representative of one of: an amount of time missing from the recording of the program; and relative temporal occurrence of missing content within the recording of the program, in response to the detection of the loss of signal condition.

3. The device of claim 2, wherein the indicator is stored in a file separate from the recording of the program and accessible in response to a request for playback.

4. The device of claim 1, wherein the processor is further operative to search an electronic program guide (EPG) for the program and the particular time period.

5. The device of claim 1, wherein the signal comprises audio and video data stream content.

6. The device of claim 1, wherein the processor also generates a loss of signal (LOS) display for display during the loss of signal condition.

7. The device of claim 1, wherein the detector detects the loss of signal condition by monitoring one of an IRE level associated with the received signal, and a synchronizing portion of the received signal.

8. A method for recording and playing back a program, comprising:
receiving a signal representative of a program transmitted during a particular time period;
storing the received program signal;
detecting occurrence of a loss of signal condition, in which the signal is not received during the particular time period; and
providing a message indicating that a portion of the program is missing from a recording of the program, in response to detection of the loss of signal condition.

9. The method of claim 8, further comprising generating an indicator representative of one of: an amount of time missing from the recording of the program; and relative temporal occurrence of missing content within the recording of the program, in response to the detection of the loss of signal condition.

10. The method of claim 8, wherein the indicator is stored in a file separate from the recording of the program and accessible in response to a request for playback.

11. The method of claim 8, further comprising searching an electronic program guide (EPG) for the program and determining the particular time period.

12. The method of claim 8, wherein the signal comprises audio and video data stream content.

13. The method of claim 8, wherein the detecting comprises monitoring one of: an IRE level associated with the received signal; and a synchronization portion of the received signal.

14. A method for playing back recorded programs, comprising:
detecting a user request to play-back a recorded program;
determining whether a loss of signal (LOS) condition is associated with the recorded program;
if a LOS condition is associated with the recorded program, generating a message indicating that a portion of the program is missing; and
displaying the message prior to playback of the recorded program.

15. The method of claim 14, further comprising:
monitoring for the loss of signal condition during while receiving the recorded program; and,
upon detection of the loss of signal condition, storing an indicator indicating a presence of the loss of signal condition in a memory and associating the indicator with the recorded program.

16. The method of claim 15, further comprising searching the memory for the indicator identifying an loss of signal condition in response to the user request.

17. The method of claim 16, further comprising suspending storage of program signals in response to the loss of signal condition.

18. The method of claim 16, further comprising:
deleting a portion of the recorded program received during the loss of signal condition.

19. The method of claim 18, further comprising:
inserting a loss of signal display in the recorded program during a portion corresponding to the loss of signal condition.

20. The method of claim 14, further comprising searching an electronic program guide for a re-broadcast of the recorded program upon detecting the occurrence of the loss of signal condition.

21. The method of claim 20, further comprising determining whether sufficient capacity exists to store the re-broadcast of the recorded program, and if so, recording the re-broadcast.
